(19) United States
(12) Patent Application Publication
(10) Pub. No.: US 2026/0352711 A1
(43) Pub. Date: Nov. 5, 2026

(54) SYSTEMS AND METHODS FOR MONITORING AND MANAGING ELECTRONIC COMMUNICATIONS IN A DISTRIBUTED NETWORK

(71) Applicant: BANK OF AMERICA CORPORATION, Charlotte, NC (US)

(72) Inventors: Amber Getty, Clayton, DE (US); Porchia L. Farrington, Land O' Lakes, FL (US); Tomeche Lowe, Jacksonville, FL (US); Nirmal Sunny, Frisco, TX (US); Andrew C. Verdone, Riverview, FL (US)

(73) Assignee: BANK OF AMERICA CORPORATION, Charlotte, NC (US)

(21) Appl. No.: 19/198,835

(22) Filed: May 5, 2025

(51) Int. Cl. H04L 9/40; H04L 67/10

(52) U.S. Cl. CPC H04L 63/20; H04L 63/1425; H04L 67/10

(57) ABSTRACT

Systems, computer program products, and methods are described herein for monitoring and managing electronic communications in a distributed network. The present disclosure is configured to receive an electronic communication associated with a plurality of systems within a distributed network via a transmission medium from an originator; identify a subset of systems of the plurality of systems within the distributed network associated with the electronic communication; summarize the electronic communication, wherein summarization comprises contents of the electronic communication and the subset of systems associated with the electronic communication; determine a set of checkpoints from the summarized electronic communication; receive clearance from the subset of systems passing the set of checkpoints; and transmit a set of updates to the originator as the set of checkpoints associated with the electronic communication are cleared.

### TECHNOLOGICAL FIELD

Example embodiments of the present disclosure relate to systems and methods for monitoring and managing electronic communications in a distributed network.

### BACKGROUND

Manual processes involved in receiving and processing electronic communications may be a time intensive and tedious process. Multiple systems in a distributed network may further contribute to inefficient and delayed communications within the distributed network.

Applicant has identified a number of deficiencies and problems associated with monitoring and managing electronic communications in a distributed network. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for monitoring and managing electronic communications in a distributed network. In one aspect, a system for monitoring and managing electronic communications in a distributed network is provided. The system may include a processing device, a non-transitory storage device containing instructions when executed by the processing device, causes the processing device to perform the steps of: receive an electronic communication associated with a plurality of systems within a distributed network via a transmission medium from an originator; identify a subset of systems of the plurality of systems within the distributed network associated with the electronic communication; summarize the electronic communication, wherein summarization comprises contents of the electronic communication and the subset of systems associated with the electronic communication; determine a set of checkpoints from the summarized electronic communication; receive clearance from the subset of systems passing the set of checkpoints; and transmit a set of updates to the originator as the set of checkpoints associated with the electronic communication are cleared.

In some embodiments, frequency and contents of the set of updates transmitted to the originator are customizable by the originator.

In some embodiments, the set of updates are transmitted to the originator via the transmission medium in which the electronic communication was received.

In some embodiments, the set of updates are transmitted to the originator on a predetermined basis.

In some embodiments, the set of updates are transmitted to the originator via a plurality of transmission mediums.

In some embodiments, the medium of transmission in which the set of updates are transmitted to the originator is an audio messaging system.

In some embodiments, transmission of the set of updates are transmitted to the originator via an auto dialer.

In another aspect, a computer program product for monitoring and managing electronic communications in a distributed network is presented. The computer program product comprising at least one non-transitory computer-readable medium having computer-readable program code portions embodied therein, the computer-readable program code portions which when executed by a processing device are configured to cause the processor to perform the following operations: receive an electronic communication associated with a plurality of systems within a distributed network via a transmission medium from an originator; identify a subset of systems of the plurality of systems within the distributed network associated with the electronic communication; summarize the electronic communication, wherein summarization comprises contents of the electronic communication and the subset of systems associated with the electronic communication; determine a set of checkpoints from the summarized electronic communication; receive clearance from the subset of systems passing the set of checkpoints; and transmit a set of updates to the originator as the set of checkpoints associated with the electronic communication are cleared.

In some embodiments, frequency and contents of the set of updates transmitted to the originator are customizable by the originator.

In some embodiments, the set of updates are transmitted to the originator via the transmission medium in which the electronic communication was received.

In some embodiments, the set of updates are transmitted to the originator on a predetermined basis.

In some embodiments, the set of updates are transmitted to the originator via a plurality of transmission mediums.

In some embodiments, the medium of transmission in which the set of updates are transmitted to the originator is an audio messaging system.

In some embodiments, transmission of the set of updates are transmitted to the originator via an auto dialer.

In another aspect, a computer-implemented method for monitoring and managing electronic communications in a distributed network is presented. The computer-implemented method comprising: identifying a subset of systems of the plurality of systems within the distributed network associated with the electronic communication; summarizing the electronic communication, wherein summarization comprises contents of the electronic communication and the subset of systems associated with the electronic communication; determining a set of checkpoints from the summarized electronic communication; receiving clearance from the subset of systems passing the set of checkpoints; and transmitting a set of updates to the originator as the set of checkpoints associated with the electronic communication are cleared.

In some embodiments, frequency and contents of the set of updates transmitted to the originator are customizable by the originator.

In some embodiments, the set of updates are transmitted to the originator via the transmission medium in which the electronic communication was received.

In some embodiments, the set of updates are transmitted to the originator on a predetermined basis.

In some embodiments, the set of updates are transmitted to the originator via a plurality of transmission mediums.

In some embodiments, the medium of transmission in which the set of updates are transmitted to the originator is an audio messaging system.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for monitoring and managing electronic communications in a distributed network, in accordance with an embodiment of the disclosure;

FIG. 2 illustrates an exemplary machine learning (ML) subsystem architecture, in accordance with an embodiment of the disclosure; and

FIG. 3 illustrates a process flow for monitoring and managing electronic communications in a distributed network, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships, or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface may include a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that may be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (e.g., distal phalanges, intermediate phalanges, proximal phalanges, and the like)), an answer to a security question, a unique intrinsic user activity (e.g., making a predefined motion with a user device), and/or the like. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources input by the plurality of users within the system. The system may further use its authentication servers to certify the identity of users of the system, such that other users may verify the identity of the certified users. In some embodiments, the entity may certify the identity of the other users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (e.g., rotationally coupled, pivotally coupled, or the like). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored, and retrieved electronically using a computing device.

As used herein, a “resource transfer,” “resource distribution,” or “resource allocation” may refer to any transactions, activities, or communications between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (e.g., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points, etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

Processing electronic communications (e.g., service level agreements, complaints, notices, and or warnings) from users may involve a plurality of systems within a distributed network. Processing, addressing, and responding to received electronic communications may further involve communicating across systems and updating users as the electronic communication is processed. Upon reception of the electronic communication, insights into the status of the electronic communication may be requested by the originator.

Communications between the plurality of systems may become difficult, particularly as it pertains to updating and informing users of the status of the electronic communication. Determining which systems complete updates and when the originator may be updated on the status of the electronic communication may face numerous obstacles. Additionally, informing and maintaining connections with the originator of the electronic communication may be held to standards within a designated time frame. Organizing updates and transmitting updates to the originator within these standards may prove challenging.

The system provides a tool to automatically organize and address notifications regarding the electronic communication to the originator of the communication. For instance, if an electronic communication is received (e.g., a complaint regarding functionality of a system), the electronic communication may be summarized and determine which subset of systems from the plurality of systems in the distributed network may be associated with the received communication. A set of checkpoints may then be created, and updates transmitted to the originator as the set of the checkpoints are cleared. Updates transmitted to the originator may be provided in a plurality of transmission mediums (e.g., matching the transmission medium the electronic communication was received and/or transmitting the set of updates via other provided transmission mediums).

Accordingly, the present disclosure describes receiving an electronic communication (e.g., a service level agreement, complaint, notice, and/or message) associated with a plurality of systems within a distributed network via a transmission medium from an originator. The electronic communication may be summarized and systems within the distributed network may be identified. The identified systems may then be used to form a set of checkpoints that may measure progress in processing the electronic communication. Upon determination of the set of checkpoints, clearance from completed checkpoints may be received which may trigger transmission of a set of updates to the originator. In other words, as the electronic communication is processed, updates may be sent to the originator to inform the originator of the status of the electronic update. Further embodiments may comprise adjusting the frequency and length of updates transmitted to the originator, changing the transmission medium in which updates are sent, and how the set of updates are transmitted. In some embodiments, machine learning models (MLMs) may be utilized within the system.

What is more, the present disclosure provides a technical solution to a technical problem. As described herein, the technical problem includes receiving and processing electronic communications. The technical solution presented herein allows for monitoring and managing electronic communications in a distributed network. In particular, monitoring and managing electronic communications in a distributed network is an improvement over existing solutions to processing electronic communications, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

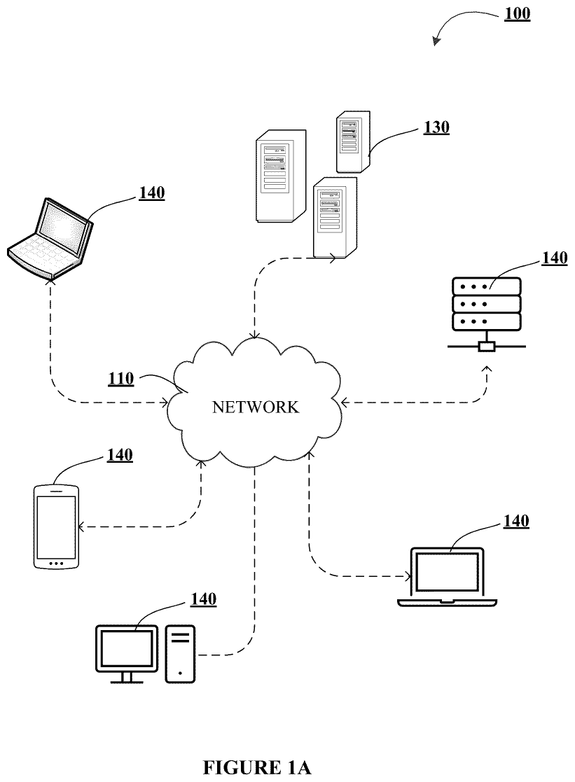

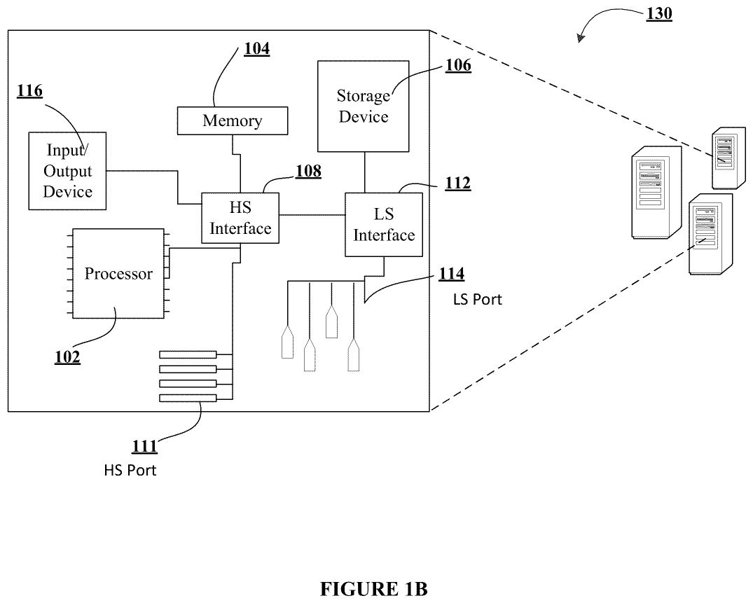

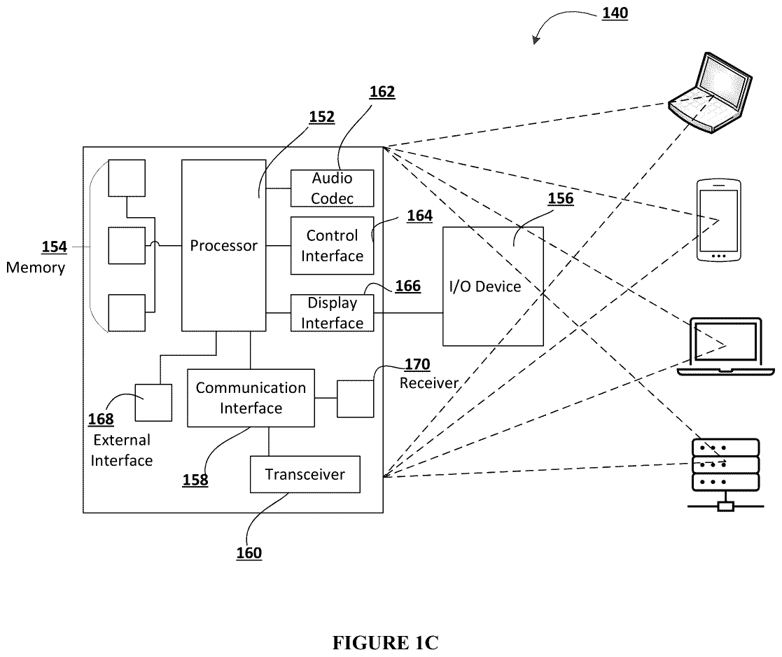

FIGS. 1A-1C illustrate technical components of an exemplary distributed computing environment for monitoring and managing electronic communications in a distributed network 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connected to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which may be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low-speed bus 114 and storage device 106. Each of the components 102, 104, 106, 108, 112 and 114 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low-speed interface/controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, the low-speed interface/controller 112 is coupled to storage device 106 and low-speed bus/expansion port 114. The low-speed bus/expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 166 may comprise appropriate circuitry and may be configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier may be a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through the communication interface 158, which may include digital signal processing circuitry where necessary. The communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, a GPS (Global Positioning System) receiver module 170 may provide additional navigation and location-related wireless data to end-point device(s) 140, which may be used as appropriate by applications running thereon, and in some embodiments, one or more applications operating on the system 130.

The end-point device(s) 140 may also communicate audibly using an audio codec 162, which may receive spoken information from a user and convert the spoken information to usable digital information. The audio codec 162 may likewise generate audible sound for a user, such as through a speaker (e.g., in a handset of end-point device(s) 140). Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described herein may be realized in digital electronic circuitry, integrated circuitry, specially designed ASICs (application specific integrated circuits), computer hardware, firmware, software, and/or combinations thereof.

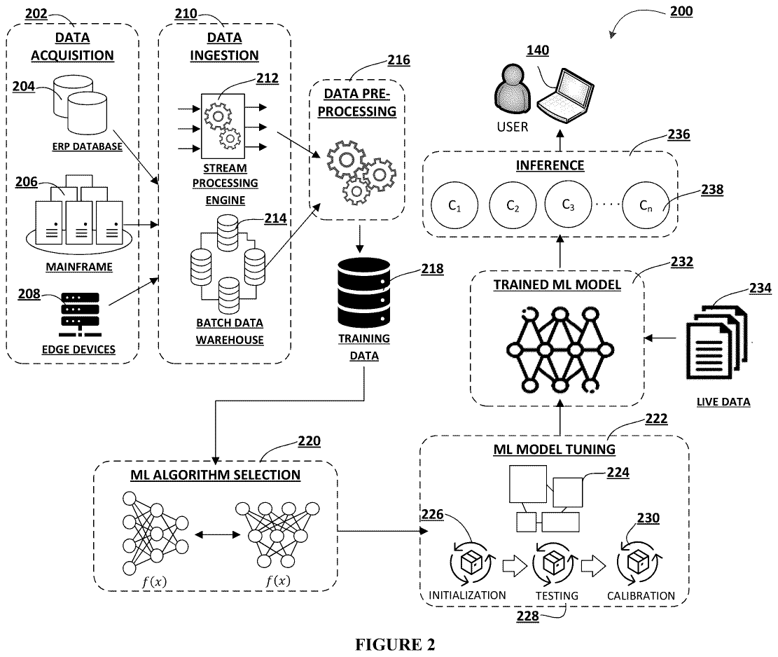

FIG. 2 illustrates an exemplary architecture of a machine learning (ML) subsystem 200, in accordance with an embodiment of the disclosure. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and may describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad of Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that may be programmed for certain applications and may transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different locations, the data may need to be cleansed and transformed so that it may be analyzed together with data from other sources. At the data ingestion engine 210, the data may be ingested in real-time, using the stream processing engine 212, in batches using the batch data warehouse 214, or in a combination of both. The stream processing engine 212 may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse 214 may collect and transfer data in batches according to scheduled intervals, triggered events, and/or any other logical ordering.

In machine learning, the quality of data and the useful information that may be derived therefrom, directly affects the ability of the machine learning model 224 to learn. The data pre-processing engine 216 may implement advanced integration and processing steps needed to prepare the data for machine learning execution. This may include modules to perform any upfront data transformations to consolidate the data into alternate forms by changing the value, structure, and/or format of the data by using generalization, normalization, attribute selection, and aggregation, to data clean by filling missing values, smoothing noisy data, resolving inconsistent data, removing outliers, and/or any other encoding steps as needed.

In addition to improving the quality of the data, the data pre-processing engine 216 may implement feature extraction and/or selection techniques to generate training data 218. Feature extraction and/or selection is a process of transforming and/or reducing the data into new features that may better represent underlying patterns in the data. Additionally, or alternatively, feature extraction and/or selection may be a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data may be enriched using one or more meaningful and informative labels to provide context such that a machine learning model may learn from the provided context. For example, labels may indicate whether a photo contains a bird or a car, which words were uttered in an audio recording, or if an x-ray contains a tumor. Data labeling is required for a variety of use cases including computer vision, natural language processing, and speech recognition. In contrast, unsupervised learning may use unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, the type and the size of the data, the available computational time, the number of features and observations in the data, and/or the like. Machine learning algorithms may refer to programs (e.g., math and logic) that may be configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation including initialization 226, testing 228, and/or calibration 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and whose model accuracy is maximized.

The trained machine learning model 232, similar to any other software application output, may be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C₁, C₂. . . Cₙ 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C₁, C₂, . . . Cₙ 238) live data 234 based on how similar they are to one another to solve exploratory challenges where little may be known about the data, provide a description or label (e.g., C₁, C₂, . . . Cₙ 238) to live data 234, such as in classification, and/or the like. These categorized outputs, groups (clusters), or labels may then be presented to the user input system 140. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

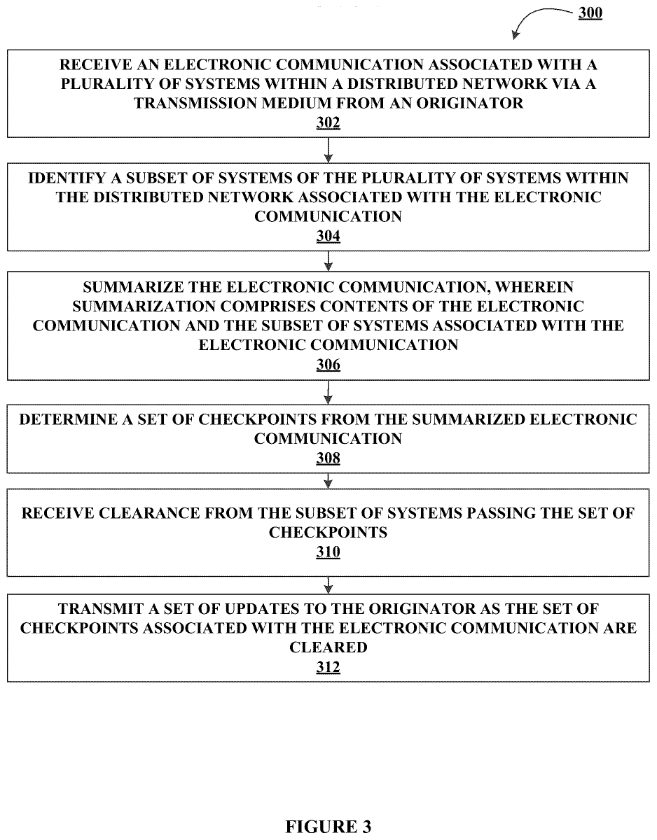

FIG. 3 illustrates a process flow for monitoring and managing electronic communications in a distributed network. In some embodiments, a system (e.g., similar to one or more of the systems described herein with respect to FIGS. 1A-1C) and a form of machine learning (e.g., similar to one or more exemplary machine learning subsystem architectures described herein with respect to FIG. 2) may perform one or more of the steps of process flow 300.

As shown in Block 302, the process flow 300 may include the step of receiving an electronic communication associated with a plurality of systems within a distributed network via a transmission medium from an originator. The electronic communication as described herein may refer to a digitally transmitted message, alert, notification, indicator, and/or data exchange received by a computing device, server, or system component within the distributed network. Electronic communications may include but may not be limited to emails, text messages (short message service (SMS) or multimedia messaging service (MMS)), push notifications, in-application alerts, voice calls (including voice over internet protocol), and/or a form of digital messaging capable of conveying information related to the status, performance, or operation of one or more systems within the network. In some embodiments, electronic communications may be automatically generated in response to a detected event or condition, such as a system error, threshold exceedance, or other operational anomaly, and may be directed to users, administrators, or other systems for the purpose of facilitating timely awareness, diagnosis, or remediation of potential issues and/or anomalies encountered. The automatically generated alert may be transmitted by the originator/point of origin within the electronic communication. In some embodiments, the electronic communication may be transmitted from an originator/point of origin in response to an encountered anomaly, issue, and/or detected event/condition.

As used herein, the term “distributed network” may refer to a system architecture comprising a plurality of interconnected computing device, nodes, or subsystems that are physically or logically separated and configured to communicate with one another over at least one communication links. The distributed network may include servers, edge devices, sensors, databases, user terminals, cloud infrastructure, or other components, that may perform at least one designated function within the overall system. Components may be geographically dispersed or co-located and may operate independently or in coordination to perform tasks such as data processing, storage, monitoring, control, and/or communication. In some embodiments, the distributed network may enable redundancy, scalability, load balancing, and/or fault tolerance. The distributed network may facilitate the detection, reporting, and management of operational conditions/events by enabling the transmission and reception of electronic communications between components, users, and/or system administrators. Communications within the distributed network may occur over various types of public or private networks, including but not limited to the internet, intranets, wireless networks, and/or virtual private networks (VPNs).

The plurality of systems as used herein may refer to a collection of distinct computing systems, software applications, services, processes and/or functional modules operating within the distributed network. A system within the plurality may be designated to carry out at least one task, operation, and/or services (e.g., data processing, resource management, communication handling, and/or user interfacing). The plurality of systems may operate independently or interdependently and may reside on the same physical device or across multiple distributed devices. In some embodiments, at least one issue/anomaly may be encountered within or across the plurality (e.g., software faults, resource constraints, connectivity anomalies, and/or unexpected behavior) potentially affecting the performance/operation of the distributed network. The issues may be detected by monitoring agents, external systems, users, and/or the point of origin/originator and may generate and transmit the electronic communications as previously described.

The transmission medium as used herein may refer to the form, channel, or mechanism by which the electronic communication is conveyed between components, users, and/or systems within the distributed network. Transmission media may include but may not be limited to email protocols (e.g., simple mail transfer protocol), text messaging services (e.g., SMS, MMS), voice communication systems, push notification services, messaging platforms (e.g., in-app messaging or chat systems), audio messaging systems, auto dialers, and other digital communication channels. In some embodiments, the transmission medium used to deliver the electronic communication may be identified, stored, and/or utilized to respond to the electronic communication as described in greater detail below. In some embodiments, the transmission medium may be selected based on priority, urgency, recipient availability, and/or contextual factors. In some embodiments, a plurality of transmission mediums (e.g., push notification systems and email protocols) may be used to respond to the electronic communication received. For instance, as described in greater detail below, the originator may transmit the electronic communication via an audio messaging system, in which case a triggered response may be transmitted via the same transmission medium (i.e., the audio messaging system) and additional transmission mediums (e.g., via an auto dialer, voice communication systems, and/or email protocols).

The originator or point of origin of the electronic communication may refer to a user, individual, group, entity, and/or source from which the electronic communication was issued. The originator of the electronic communication may issue the electronic communication after encountering an anomaly, issue, and/or unexpected behavior within the distributed network. In other words, the electronic communication issued by the originator may comprise a notice of problems or anomalous behavior encountered within the distributed network, e.g., an inquiry into the status of the corrective activity deployed to address the problems or anomalous behavior. The originator may transmit the electronic communication via a selected transmission medium, and responses to the electronic communication may be transmitted via a matching transmission medium as described in greater detail below.

As shown in Block 304, the process flow 300 may include the step of identifying a subset of systems within the plurality of systems within the distributed network associated with the electronic communication. The subset of systems within the plurality may comprise identifying systems that may be associated with the received electronic communication. For instance, the electronic communication may comprise identifications, mentions, requests, and/or content directed to the subset of systems. In other words, the electronic communication may identify the subset of systems within the distributed network directly or indirectly. In some embodiments, the electronic communication may identify systems connected, related, and/or dependent on the identified subset of systems (e.g., a system within the plurality is identified and a system from which it depends on may be identified). In some embodiments, the subset of systems may be selected by a machine learning model, as previously described in FIG. 2. In some embodiments, the identification of the subset of systems may be conducted by a first machine learning model (MLM), wherein a second (MLM) may summarize the electronic communication as described in greater detail below. The first MLM may be trained to identify systems mentioned, associated with, and/or targeted by the electronic communication. The second MLM may be trained to summarize received electronic communications.

As shown in Block 306, the process flow 300 may include the step of summarizing the electronic communication, wherein summarization comprises contents of the electronic communication and the subset of systems associated with the electronic communication. Summarization of the electronic communication may identify the main points, systems affected by encountered anomalies, and/or unexpected conditions deviating from established behavior. For instance, the electronic communication may comprise a notice of systems behaving unexpectedly (e.g., a response from a specified system has not been received in the expected length of time), wherein the summarization may indicate the system mentioned, the unexpected behavior, and associated systems. The systems listed within the summarization may be identified as previously described.

As shown in Block 308, the process flow 300, may include the step of determining a set of checkpoints from the electronic communication. Determining the set of checkpoints from the electronic communication may utilize the summarization of the electronic communication to determine when/if a message or set of updates may be transmitted as the electronic communication is processed. For instance, an electronic communication may be comprised of steps, processes, and/or milestones while being processed (e.g., the electronic communication has been received, the electronic communication has been elevated to a higher authority, the electronic communication may be processed within a predetermined length of time) which may be transmitted to the originator as the set of checkpoints are cleared. Transmission of cleared checkpoints may be directed toward the originator of the electronic communication.

The set of checkpoints may be cleared by individual systems within the subset of systems. For instance, the set of checkpoints may comprise a first set of checkpoints that may be cleared by a first system within the subset, a second set of checkpoints may be cleared by a second system within the subset, and so on. Each system within the subset of systems may transmit responses which may be processed and compared against the set of checkpoints. As responses from the subset of systems is received, the set of checkpoints may be updated and trigger transmission of a set of updates to the originator, as described in greater detail below.

In some embodiments, the set of checkpoints may be determined via a machine learning model (MLM) as described within FIG. 2. The MLM may utilize data from previously received electronic communications to determine the subset of systems within the plurality of systems are associated with the electronic communication.

As shown in Block 310, the process flow 300, may include the step of receiving clearance from the subset of systems passing the set of checkpoints. Clearance from the subset of systems may be received piecemeal/gradually, with signals from individual systems within the subset transmitting clearance as the electronic communication is processed. For instance, there may be a subset of the set of checkpoints in which the first system may clear/process. As the first system within the subset processes the set of checkpoints directed to the first system updates on the progress of the set of checkpoints may be transmitted. In some embodiments, completion of at least a portion of the set of checkpoints may trigger transmission of a message to the originator regarding the progress of the electronic communication. Clearance from at least a portion of the checkpoints may be received from a plurality of systems within the subset to indicate progress on the set of checkpoints. For instance, systems within the subset may have processed the electronic communication above a predetermined threshold (e.g., 50%) before transmitting clearance for the set of checkpoints. The groups of systems within the subset and the portion of the checkpoints that may be completed to transmit a set of updates to the originator may be configured depending on the systems within the subset, the summarization of the electronic communication, and processing of the electronic communication, as described in greater detail below.

As shown in Block 312, the process flow 300, may include the step of transmitting a set of updates to the originator as the set of checkpoints associated with the electronic communication are cleared. Transmission of the set of updates to the originator may comprise transmission of an electronic communication to the originator. The set of updates may, in some embodiments, match the transmission medium in which the electronic communication was received. The set of updates may be transmitted to the originator by a plurality of transmission mediums. For instance, if the originator has multiple mediums of transmission in which the set of updates may be transmitted, the set of updates may be transmitted via the plurality of available transmission mediums.

In some embodiments, frequency, contents, and volume of the set of updates transmitted to the originator may be customizable by the originator. For instance, the originator may be prompted on the frequency in which the originator may receive updates (e.g., as each checkpoint from the set of checkpoints is cleared, the time in which the electronic communication is processed, receiving updates over a predetermined length of time). The frequency in which the set of updates may be transmitted may be customized, adjusted, configured, and/or modified by the originator before and during processing of the electronic communication. In some embodiments, content of the set of updates may be customized by the originator. For instance, the set of updates may indicate the procedures/stages/checkpoints the electronic communication is clearing. In another instance, the set of updates may indicate the time in which the electronic communication is projected/predicted to finish processing. In another instance, the set of updates may comprise notifications indicating which systems, teams, and/or groups may be processing the electronic communication. The originator may adjust the content and frequency in which the set of updates may be transmitted before processing of the electronic communication and during processing of the electronic communication. For instance, the originator may indicate that the set of updates may be transmitted to the originator on a predetermined length of time (e.g., the set of updates may be transmitted to the originator every hour before the electronic communication is processed).

In some embodiments, the set of updates may be transmitted to the originator on a predetermined basis. The predetermined basis may comprise transmitting the set of updates regularly/periodically while the electronic communication is being processed. For instance, the set of updates may be transmitted to the originator after a predetermined amount of time has passed (e.g., the set of updates may be transmitted to the originator every hour while the electronic communication is being processed). In some embodiments, the predetermined basis may comprise transmitting the set of updates for a cyclical event (e.g., the set of updates may be transmitted each evening at a configurable time). In another instance, the set of updates may be transmitted to the originator after a predetermined signal is received from the originator. For instance, a message, notification, alert, and/or request from the originator may be received and trigger the set of updates to be transmitted to the originator.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for monitoring and managing electronic communications in a distributed network, the system comprising:
at least one non-transitory storage device; and
at least one processing device coupled to the at least one non-transitory storage device, wherein the at least one processing device is configured to:
receive an electronic communication associated with a plurality of systems within a distributed network via a transmission medium from an originator;
identify a subset of systems of the plurality of systems within the distributed network associated with the electronic communication;
summarize the electronic communication, wherein summarization comprises contents of the electronic communication and the subset of systems associated with the electronic communication;
determine a set of checkpoints from the summarized electronic communication;
receive clearance from the subset of systems passing the set of checkpoints; and
transmit a set of updates to the originator as the set of checkpoints associated with the electronic communication are cleared.

2. The system of claim 1, wherein frequency and contents of the set of updates transmitted to the originator are customizable by the originator.

3. The system of claim 2, wherein the set of updates are transmitted to the originator via the transmission medium in which the electronic communication was received.

4. The system of claim 1, wherein the set of updates are transmitted to the originator on a predetermined basis.

5. The system of claim 1, wherein the set of updates are transmitted to the originator via a plurality of transmission mediums.

6. The system of claim 1, wherein the transmission medium in which the set of updates are transmitted to the originator is an audio messaging system.

7. The system of claim 6, wherein transmission of the set of updates are transmitted to the originator via an auto dialer.

8. A computer program product for monitoring and managing electronic communications in a distributed network, the computer program product comprising at least one non-transitory computer-readable medium having computer-readable program code portions embodied therein, the computer-readable program code portions being configured to:
receive an electronic communication associated with a plurality of systems within a distributed network via a transmission medium from an originator;
identify a subset of systems of the plurality of systems within the distributed network associated with the electronic communication;
summarize the electronic communication, wherein summarization comprises contents of the electronic communication and the subset of systems associated with the electronic communication;
determine a set of checkpoints from the summarized electronic communication;
receive clearance from the subset of systems passing the set of checkpoints; and
transmit a set of updates to the originator as the set of checkpoints associated with the electronic communication are cleared.

9. The computer program product of claim 8, wherein frequency and contents of the set of updates transmitted to the originator are customizable by the originator.

10. The computer program product of claim 9, wherein the set of updates are transmitted to the originator via the transmission medium in which the electronic communication was received.

11. The computer program product of claim 8, wherein the set of updates are transmitted to the originator on a predetermined basis.

12. The computer program product of claim 8, wherein the set of updates are transmitted to the originator via a plurality of transmission mediums.

13. The computer program product of claim 8, wherein the transmission medium in which the set of updates are transmitted to the originator is an audio messaging system.

14. The computer program product of claim 13, wherein transmission of the set of updates are transmitted to the originator via an auto dialer.

15. A computer-implemented method for monitoring and managing electronic communications in a distributed network, the computer-implemented method comprising:
receiving an electronic communication associated with a plurality of systems within a distributed network via a transmission medium from an originator;
identifying a subset of systems of the plurality of systems within the distributed network associated with the electronic communication;
summarizing the electronic communication, wherein summarization comprises contents of the electronic communication and the subset of systems associated with the electronic communication;
determining a set of checkpoints from the summarized electronic communication;
receiving clearance from the subset of systems passing the set of checkpoints; and
transmitting a set of updates to the originator as the set of checkpoints associated with the electronic communication are cleared.

16. The computer-implemented method of claim 15, wherein frequency and contents of the set of updates transmitted to the originator are customizable by the originator.

17. The computer-implemented method of claim 16, wherein the set of updates are transmitted to the originator via the transmission medium in which the electronic communication was received.

18. The computer-implemented method of claim 15, wherein the set of updates are transmitted to the originator on a predetermined basis.

19. The computer-implemented method of claim 15, wherein the set of updates are transmitted to the originator via a plurality of transmission mediums.

20. The computer-implemented method of claim 15, wherein the transmission medium in which the set of updates are transmitted to the originator is an audio messaging system.
